(19) United States
(12) Patent Application Publication
(10) Pub. No.: US 2024/0198313 A1
(43) Pub. Date: Jun. 20, 2024

(54) MICROWAVE-ASSISTED, SILICA-BASED COMPOSITE DESICCANT DEHUMIDIFICATION METHOD AND SYSTEM

(71) Applicant: KING ABDULLAH UNIVERSITY OF SCIENCE AND TECHNOLOGY, Thuwal (SA)

(72) Inventors: Faheem Hassan AKHTAR, Thuwal (SA); Muhammad BURHAN, Lahore (PK); Qian CHEN, Thuwal (SA); Kim Choon NG, Singapore (SG); Muhammad Wakil SHAHZAD, Rahim Yar Khan (PK); Peng WANG, Thuwal (SA); Kaijie YANG, Thuwal (SA); Doskhan YBYRAIYMKUL, Almaty (KZ)

(21) Appl. No.: 18/684,050

(22) PCT Filed: Aug. 17, 2022
(86) PCT No.: PCT/IB2022/057705

§ 371 Date: Feb. 15, 2024

Related U.S. Application Data
(60) Provisional application No. 63/235,195, filed on Aug. 20, 2021.
(60) Provisional application No. 63/235,197, filed on Aug. 20, 2021.

(51) Int. Cl. B01J 20/04; B01D 53/06; B01D 53/26; B01J 20/10; B01J 20/28; B01J 20/32; F24F 3/14

(52) U.S. Cl. CPC B01J 20/046; B01D 53/06; B01D 53/261; B01J 20/103; B01J 20/28004; B01J 20/28019; B01J 20/28097; B01J 20/3204; B01J 20/3236; B01J 20/3293; F24F 3/1423; B01D 2253/106; B01D 2253/304; B01D 2253/3425; B01D 2257/80; B01D 2259/40094; B01D 2259/652; F24F 2003/144; F24F 2003/1458; F24F 2203/1032

(57) ABSTRACT

A composite adsorbent for adsorbing water includes a silica-cage having plural pores and internal channels that fluidly connect the plural pores, at least one interior chamber having an average diameter larger than an average diameter of the plural pores, wherein the at least one interior chamber is a result of a collapse of at least one pore of the plural pores and one channel of the internal channels, and a salt provided within the plural pores, the internal channels and the at least one interior chamber.

### CROSS-REFERENCE TO RELATED APPLICATIONS

This application claims priority to U.S. Provisional Patent Application No. 63/235,195, filed on Aug. 20, 2021, entitled “HIGH PERFORMANCE DESICCANT SYSTEM FOR EFFICIENT DEHUMIDIFICATION IN AIR CONDITIONING,” and U.S. Provisional Patent Application No. 63/235,197, filed on Aug. 20, 2021, entitled “INNOVATIVE MICROWAVE ASSISTED DESICCANT DEHUMIDIFICATION METHOD AND SYSTEM,” the disclosures of which are incorporated herein by reference in their entirety.

### BACKGROUND

### Technical Field

Embodiments of the subject matter disclosed herein generally relate to a system and method for dehumidifying an air flow for an air conditioning system, and more particularly, generating a high-efficiency desiccant material and using microwaves to regenerate the desiccant material in the air conditioning system.

### Discussion of the Background

Water vapor is a component to be considered in many industrial applications like flue gas dehydration, dehydration of natural gas, compressed air drying, storage of fruit and vegetables, protective apparel, and dehumidification processes to improve indoor air quality. The presence of water vapor in process streams (e.g., gas stream) or enclosed spaces (e.g., household or office) is not always desirable and needs to be controlled. For example, water vapor present in natural gas can create significant problems like hydrate formation, slug flow, corrosion, and erosion in the pipelines and processing equipment. The removal of water from flue gas would avoid reheating after the gas desulfurization unit processing, reducing energy requirements, and increasing the overall efficiency of a power plant. Another fast-growing application of water removal is air dehumidification, an essential function in air-conditioning systems, aviation, and space flights to provide humidity control for human comfort.

The energy usage for the HVAC (heating, ventilation, and air conditioning) system is overgrowing, and a significant part of the total primary energy consumption is utilized in air dehumidification processes for the HVAC systems. In the U.S., almost half of the energy consumption in buildings is accounted for the cooling systems, which constitute about 20% of the total energy consumption. This is considered to be one of the largest energy end-use not only in the residential sector but also in the industrial sector.

Moreover, the persistent goal of energy consumption has made it a key priority for energy policies to develop new regulations for buildings. A prominent example is the European directive for Energy Performance of Buildings (EPBD), which proposes high standards for energy efficiency in ventilation and air-conditioning systems. The energy demand for air-conditioning is expected to increase rapidly during the 21st century due to changing climatic conditions, which decrease global heating demand and increase cooling demand significantly. According to modeled predictions, the energy demand is expected to grow from 300 TWh (terawatt hours) in 2000, to about 4000 TWh in 2050 and more than 10,000 TWh in 2100. Therefore, the world demand for HVAC equipment and associated energy consumption is proliferating. According to a recent forecast report about HVAC equipment, annual growth for HVAC equipment has increased from 4.4 (2008-2013) to more than 120 billion $ at a yearly growth rate of 6% during the 2013-2018 period. This means that energy usage is also expected to grow accordingly.

To mitigate this issue, membrane or desiccant-based dehumidification systems have the potential to reduce energy usage up to certain levels [1, 2]. Although membranes are compact systems, their use in the cooling industry is yet to be matured. Therefore, adsorbents or their coatings are preferred. An ideal adsorbent material should swiftly adsorb water vapor as the humidity level exceeds the undesired range. Such materials, if available, will pave the way toward alleviating the various existing burdens imposed by currently deployed techniques pertaining to the design capacity, energy efficiency, and overall cost.

One prerequisite for using adsorption materials is high water uptake, i.e., the material needs to be capable to adsorb a large amount of water, and for this reason, various materials including membranes, adsorbents, e.g., metal organic frameworks (MOFs), and covalent organic frameworks (COFs) are currently being researched. However, their lack of large-scale production processes and high-cost limit their use in practical industrial applications. Silica-based materials have been used over the years as adsorbents. Recently, they have gained more attention, and their performance improvement options have been exploited. For these purposes, researchers have used various preparation techniques, e.g., polymer grafting.

However, finding a good adsorption material is only one aspect of an electrically efficient air conditioning system. Another aspect is how to regenerate the adsorption material after it is saturated with water, so that the adsorption material can be reused. In this regard, the current air conditioning systems achieve dehumidification by dew-point condensation of the water vapor in the airstream using a dual-role AC chiller that has reached its asymptotic performance limit, 0.85 KW/Rton (equivalent to a coefficient of performance (COP) of 4-4.5). One of the solutions to improve the performance of the AC unit is to decouple dehumidification from sensible cooling, thus permitting the incorporation of new dehumidification methods.

Microwave dehumidification is an emerging method, where water molecules are attracted on a solid desiccant pore surface to dehumidify the air, and then the adsorbed water is removed by microwave irradiation. The former process is named adsorption, and the latter is known as desorption. From the available literature, [2] demonstrated the first microwave dehumidification process with a single-mode waveguide. The authors presented the dependence of desiccant temperature on the electrical field intensity. Moreover, they proposed a model to represent the fast kinetics of microwave desorption. Most of the research within the last decades has been focused on developing the microwave-assisted desorption method within small volumes [3-9]. Notably, the desiccant material investigation was extended with different adsorbents (activated alumina, zeolite, silica gel) [5].

Many advantages of microwave desorption were shown, such as transferring energy more efficiently than convection energy transport and desorbing at low temperatures due to direct energy transport. However, a critical parameter such as the coefficient of performance (COP) was usually omitted in the literature. In addition, no electrical power values were provided; instead, microwave power was shown. Therefore, a microwave coefficient of performance (MCOP) was introduced, which can be the platform for comparing different microwave dehumidification systems. MCOP can be calculated using microwave power, duration of the microwave exposure, and amount of water desorbed. The calculated values of MCOP for different authors were extremely low (lower then 0.2). The system's performance depends on the uniform propagation of the electric field intensity, the geometry of the microwave chamber, microwaves irradiation time, mode of irradiation, and reflected power amount. A multi-mode chamber system similar to a home oven could improve its performance; nevertheless, MCOP was around 0.15. Furthermore, a fixed zeolite-coated desiccant rotor was regenerated using microwave and temperature swing desorption methods, but the performance was in low, with a MCOP around 0.18 [8, 9]. In addition to the low COP and MCOP, the systems discussed in [4-9] focus on small systems, e.g., having a volume less than 1 liter. Such small systems behave differently than a real size system as the electric field intensity corresponding to the microwaves is not uniform in a larger volume.

Thus, there is a need for a new adsorbent material and also a large-scale microwave-based dehumidification system that is capable of adsorbing large amounts of water and also efficiently regenerating the adsorbent material.

### BRIEF SUMMARY OF THE INVENTION

According to an embodiment, there is a composite adsorbent for adsorbing water, and the composite adsorbent includes a silica-cage having plural pores and internal channels that fluidly connect the plural pores, at least one interior chamber having an average diameter larger than an average diameter of the plural pores, wherein the at least one interior chamber is a result of a collapse of at least one pore of the plural pores and one channel of the internal channels, and a salt provided within the plural pores, the internal channels and the at least one interior chamber.

According to another embodiment, there is an air dehumidification system for removing water vapor from an air flow. The air dehumidification system includes a first Faraday cage configured to confine microwaves, a desiccant wheel located within the first Faraday cage and configured to rotate relative to a longitudinal axis X of the first Faraday cage, wherein the desiccant wheel is coated with a desiccant material, a metallic plane that extends through a diameter DD of the desiccant wheel and divides the desiccant wheel into a first half and a second half, and a magnetron system configured to generate the microwaves and direct them into the desiccant wheel to evaporate water adsorbed by the desiccant material. The metallic plane is configured to, at a given instant, uniformly distribute the microwaves into the first half of the desiccant wheel and to prevent the microwaves from the entering the second half.

According to yet another embodiment, there is a method for manufacturing a composite adsorbent for adsorbing water, and the method includes providing a silica-cage having plural pores and internal channels that fluidly connect the plural pores, preparing an aqueous salt that includes a salt, placing the silica-cage in the aqueous salt to form at least one interior chamber, which is a result of a collapse of at least one pore of the plural pores and one channel of the internal channels, removing the silica-cage loaded with the salt from the aqueous salt, and drying the silica-cage loaded with the salt.

### BRIEF DESCRIPTION OF THE DRAWINGS

For a more complete understanding of the present invention, reference is now made to the following descriptions taken in conjunction with the accompanying drawings, in which:

FIGS. 1A and 1B are schematic diagrams of a silica-cage having plural pores and channels and FIG. 1C is a cross-section of the silica-cage having at least one internal chamber formed when the walls of at least one pore and one channel collapse and the internal chamber is filled with a salt;

FIG. 2 is a flow chart of a method for manufacturing a composite adsorbent based on the silica-cage and the salt shown in FIGS. 1A to 1C;

FIG. 3 shows the water uptake of various silica-based materials including the composite adsorbent manufactured by the method of FIG. 2;

FIG. 4 shows the change in the water uptake of the composite adsorbent under increasing and decreasing relative humidity;

FIG. 5 is a schematic diagram of an air conditioning system that includes an air dehumidification system and an air cooling device;

FIG. 6 illustrates a desiccant wheel used by the air dehumidification system of FIG. 5;

FIG. 7 illustrates a honeycomb structure of the desiccant wheel of FIG. 6;

FIG. 8 is a table that illustrates various properties and characteristics of the desiccant wheel of FIG. 6;

FIG. 9A illustrates adsorption isotherms of the combined desiccant wheel, adsorbent, and binder, while FIG. 9B illustrates the dielectric properties of the composite desiccant material with different adsorption uptakes;

FIG. 10 illustrates the microwaves distribution within the desiccant wheel when a metallic plane is placed inside the wheel;

FIG. 11A shows temperature and humidity ratio profiles at the inlet and outlet of the dehumidification system without a heat recovery device being on while FIG. 11B shows the same when the heat recovery device is present and turned on;

FIG. 12 schematically illustrates how the COP and MCOP are calculated for the air dehumidification system;

FIG. 13A shows the COP for existing air dehumidification systems and the system shown in FIG. 5 while FIG. 13B shows the MCOP for the existing systems versus the system shown in FIG. 5;

FIG. 14A schematically shows an air conditioning system that includes the air dehumidification system shown in FIG. 5 and an air-cooling device working together to cool the air in a chamber; FIGS. 14B to 14D show variations of the air conditioning system of FIG. 14A, with FIG. 14B showing a system having two dessicant wheels, each with corresponding microwave generator, FIG. 14C showing a system having three desiccant wheels, each with corresponding microwave generator, and FIG. 14D showing a system having two desiccant wheels that share a single microwave generator,

FIG. 15 schematically shows another air conditioning system that uses a microwave-assisted air dehumidification system and an air-cooling device to cool the air in a chamber;

FIG. 16 schematically shows how the incoming humid air flow is dehumidified using a desiccant material; and

FIG. 17 illustrates how the desiccant material is regenerated using microwave radiation.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to an adsorbent material that includes silica cages filled with a hydrophilic salt and this adsorbent material is used in an air conditioning system to remove the humidity from the incoming air stream prior to cooling the air stream. However, the embodiments to be discussed next are neither limited to such a system nor to the specific adsorbent material to be discussed herein.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a silica-cage based composite adsorbent is produced so that after impregnation with a salt, the cage's internal structure remains mostly intact (except for the collapse of some of the pores and channels that form large internal chambers), maintains its mechanical stability, and is capable to adsorb up to 530% water relative to its dry mass. This composite adsorbent or another desiccant material may be used to coat a rotor, which includes a rotating reflector for uniformly distributing the electrical field associated with the microwave irradiation. These features are now discussed in more detail with regard to the figures.

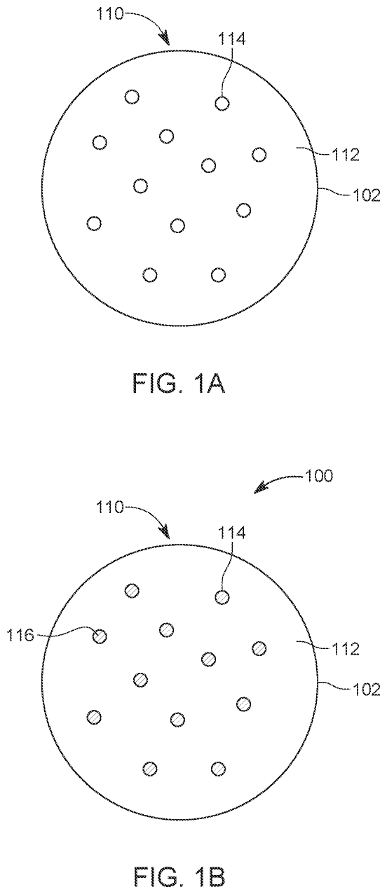

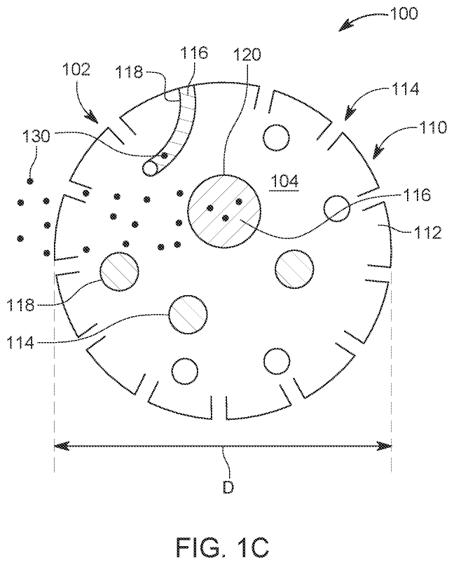

FIGS. 1A to 1C illustrate a single silica-cage 110, also called silica particle. While FIGS. 1A and 1B shows the external surface 102 of the silica-cage 110, FIG. 1C shows a cross-section through the silica-cage 110, i.e., it shows an internal surface 104 of the silica-cage. The silica-cage 110 has a porous body 112 made of silica. The porous body 112 has plural pores 114 (external and internal) that communicate, as shown in FIGS. 1A and 1B, with an ambient of the silica-cage. A hydrophilic salt 116 is added to the silica-cage 110 so that part of the internal pores 114 are filled with the salt. The silica-cage 110 together with the hydrophilic salt 116 form the composite adsorbent 100. FIG. 1C shows that as a result of this process, which is discussed in more detail next, some of the pores 114 and associated internal tunnels 118 have collapsed and formed large interior chambers 120. The term “large” is used herein to indicate that an average diameter of the interior chambers 120 is larger than an average diameter of the pores 114. A large interior chamber 120 is formed when at least one interior pore 114 and one channel 118 connected to the interior pore 114 have collapsed.

In one embodiment, a volume of the interior chamber 120 is larger than a sum of the volume of one pore 114 and the volume of one channel 118. Note that the silica-cage 110 is defined as having a network of tunnels 118 that connects the pores 114 to each other and some of the tunnels connect to each other. Thus, the pores 114 and tunnels 118 make the silica-cage to have a porous structure, i.e., a large volume of interior chambers. For those tunnels 118 that have not collapsed, they preserve their interior original diameter. Both the original tunnels 118 and the newly formed interior chambers 120 may be partially or even totally filled with the salt 116. FIG. 1C shows only some of the tunnels 118 filled with the salt 116, but any number of these channels may be filed with the salt. This open porous structure of the composite adsorbent 100 allows a maximum impregnation of the cage 110 with the salt 116, and also has a mechanical stability that prevents the remaining channels 118 of the cage 110 to further collapse. This is a known problem for the existing adsorbent material, i.e., the interior structure of the cage collapses and the material deposited inside the cage leaks out.

In one application, the salt 116 is selected to be LiCl. However, the salt 116 may also be based on other cations, e.g., Na, K, Mg, Ca, an Sr. In one application, the salt may be based on other anions, for example, Br. A size D (see FIG. 1C for size D, which corresponds to an external diameter of the particle 110) of a single cage/particle 110 is between 5 and 75 μm, with a preferred size being between 6 and 15 μm. The loading of the silica-cage 110 with the salt 116 is between 30 and 65%, with a preferred loading between 60 and 65%. In one embodiment, the loading is about 62%, with the term “about” meaning plus or minus 10%. The term “loading” refers to the volume of empty space (i.e., pores, channels and internal chambers) that is filled with the salt.

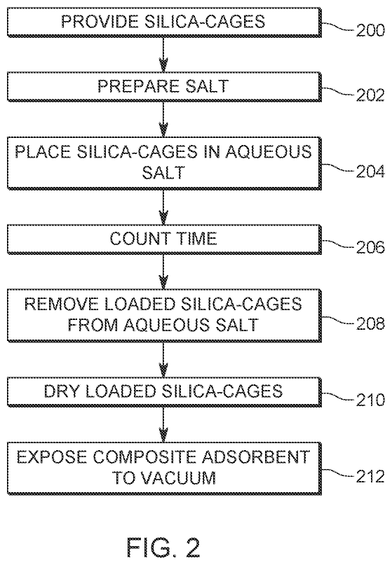

A method for loading the silica-cage 110 with the salt 116 for obtaining the composite adsorbent 100 is now discussed with regard to FIG. 2. Silica cages 110 are provided in step 200. Note that a silica-cage 110 is different from a traditional silica particle as the traditional silica particle does not have the pores 114 and tunnels 118 illustrated in FIG. 1C and the corresponding porous structure. A lithium chloride (LiCl) salt is prepared in step 202. The salt is dissolved in a given amount of water so that the salt is aqueous. In step 204, the silica-cage 110 is placed in the aqueous salt and the salt enters the plural channels 118, through the corresponding pores 114. Thus, in this step the silica-cage 110 is loaded with the salt 116. The amount of loaded salt depends on the amount of time that the silica cage is kept in the aqueous salt. The longer the time, the larger the loading factor. In step 206, a given time is counted so that the silica cage is loaded with about 62% salt. In step 208, the loaded silica cage, i.e., the composite adsorbent 100 is removed from the aqueous salt and in step 210 the composite adsorbent is dried, for example, with hot drying air at a temperature of about 60 to 70° C. In an optional step 212, the composite adsorbent 100 is placed in a sealed container and exposed to vacuum, to further the deposition of the salt inside the channels and interior chambers of the silica-cage. Depending on the size of the silica-cage (x) and the loading percentage (y), in the following, a composite adsorbent is referred to as SCx-y. For the method discussed herein, as the average size D of the silica-cages is about 6 μm, and thus the obtained composite adsorbent is called SC6-62. Other values for y studied herein were 37 and 50%, and other sizes of the cages studied here were 20 and 75 μm. Any other combination of numbers for x and y may be used. Note that an exterior surface 102 of the silica-cage 110 is free of the salt 116. Also note that water 130 (see again FIG. 1C) from the ambient is adsorbed through the silica body 112 and/or the salt 116 into the channels 118 and the larger interior chambers 120.

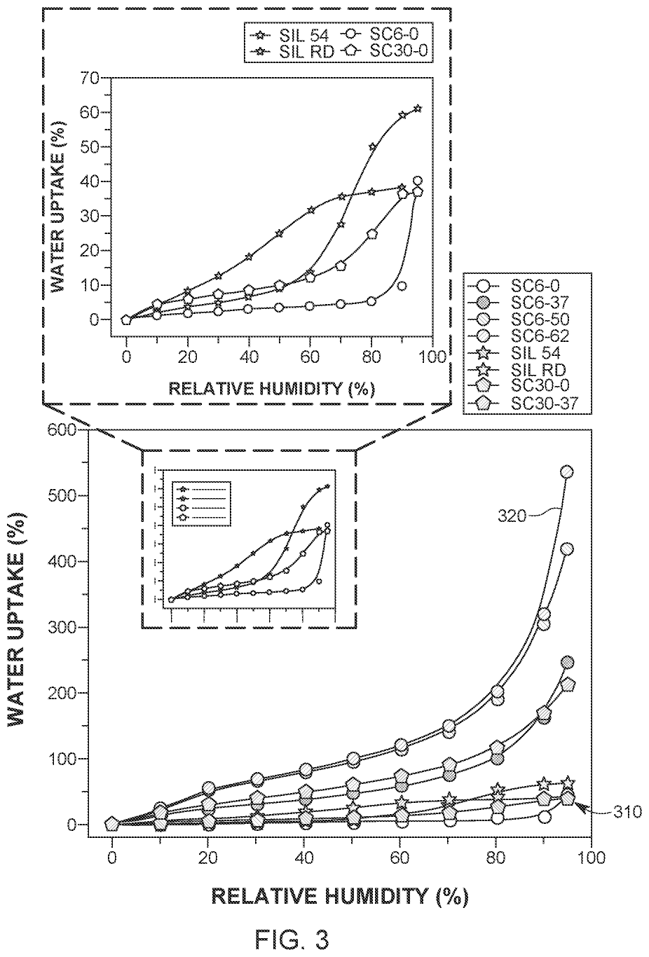

The properties of the novel composite adsorbent 100 have been studied as now discussed. Water vapor sorption/desorption isotherms of a pristine (i.e., traditional) silica-cage, and the composite adsorbent 100 discussed above were determined at 25° C. Water vapor sorption isotherms of various porous silica cages is shown in FIG. 3. It is noted that the porous cage has a maximum water uptake of 40% at 25° C., as indicated at 310. The inset image of FIG. 3 shows the commercially available Silica particles (SIL 54, SIL RD) having a water vapor uptake similar to the silica cages SC6-0 and SC30-0. Note that the commercially available Silica particles SIL 54 and SIL RD illustrated in FIG. 3 do not have pores, channels and interior chambers. The water uptake increases with the increase in the loading of LiCl, as also shown in FIG. 3. All the samples exhibited type II isotherms, suggesting their highly hydrophilic properties, and water uptake increase with the increase in the relative humidity. In sharp contrast, the novel SC6-37 and SC30-37 composite adsorbents 100 showed a similar water vapor uptake over the entire humidity range.

The inventors conducted a further analysis for the silica-cage having an exterior diameter of about 6 μm. The water uptake of this composite adsorbent 100 increased with the relative humidity and the sorption curve ascended monotonically above RH=20%, indicating the formation of an aqueous solution of the salt 116, and reaching a maximum water uptake of 530% (of the mass of the dry composite adsorbent) when the LiCl loading was about 62% (see FIG. 3, curve 320). Note that the water uptake is calculated by measuring a ratio between the mass of the amount of water adsorbed and the mass of the dry composite adsorbent, while the LiCl loading is calculated as a ratio between (1) a volume occupied by the LiCl within the silica-cage, and (2) a total volume of the empty chambers 120, pores 114, and channels 118 in the silica-cage 110. The high-water uptake for the composite adsorbent 100 is due to the strong affinity of water vapor with the salt and silica. The water uptake of the composite adsorbents is very high compared to the state-of-the-art porous materials [4-7], composite adsorbents [8, 9], and various polymers.

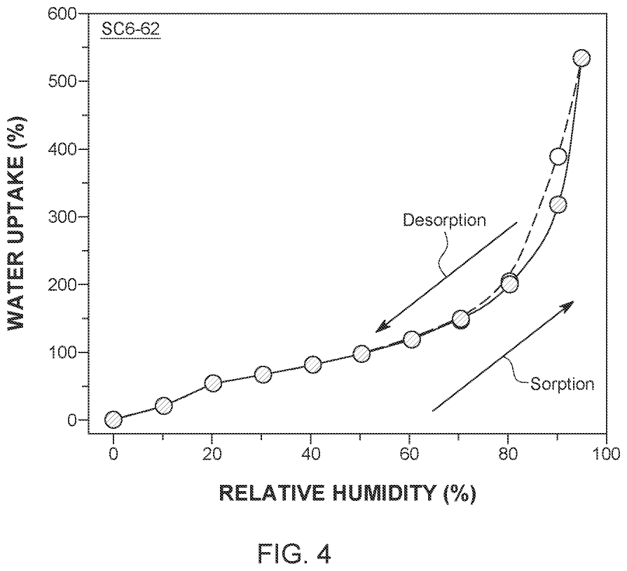

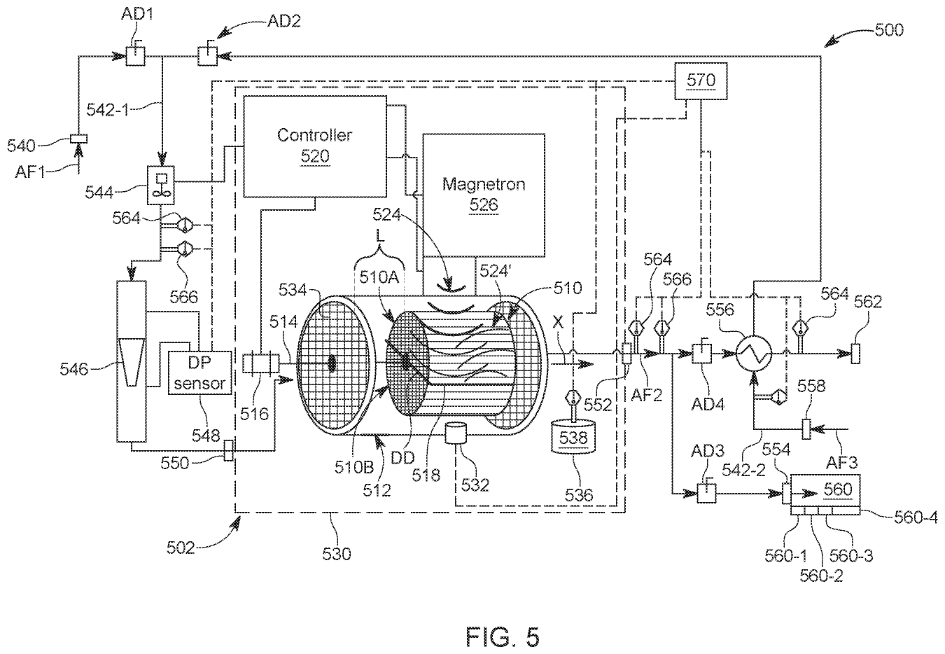

The water vapor uptake of the fully activated composite adsorbent 100 yields a very high-water uptake when RH≥60%. As mentioned earlier, it is anticipated that the LiCl addition plays a pivotal role in enhancing the water uptake. However, similar systems have the drawback of LiCl leakage as a result of host matrix collapse. The unique structure of the silica cage for the composite adsorbent 100 prevents such leakage. To further study this advantage of the adsorbent 100, a sorption-desorption analysis was performed with the highest loading of LiCl (SC6-62). The results, which are shown in FIG. 4, show the presence of a minimal hysteresis loop at a relative humidity above 80% due to strong hydrogen bonding interactions at high humidity. It is likely that the water sorption occurs in the following steps: the anhydrous LiCl confined in the silica cage adsorbs water and transforms to crystalline composite, then this structure adsorbs more water, and finally, LiCl is completely dissolved filling the voids/pores 118/120 of the body 112 of the cage. The inventors also performed plural water sorption-desorption cycles by alternatively exposing SC6-37 over the entire humidity range above 40% RH. Unexpectedly, the maximum water uptake remained the same for the whole range of relative humidities, confirming the stability of this composite adsorbent to water sorption/desorption processes.

To further determine the unique water adsorption properties associated with the composite adsorbent 100 and assess the effect of the temperature on the water uptake for SC6-37, additional water adsorption studies at temperatures close to the moisture-control working range (i.e., 35 and 45° C.) were performed. The results indicate a behavior for all these samples similar to the 25° C. sample. The dynamics of water vapor sorption were assessed under a range of conditions for the four composite adsorbents and were compared with the commercial silica-based adsorbents. The rate of water uptake over time exhibited a stable relationship. It was found that the rate of water uptake for commercial desiccants (Silica type RD and Silica type 54) is the highest at low relative humidity and decreases with the increase in relative humidity. The maximum water uptake rate was 0.12%/min for these desiccants. However, the silica cage shows an opposite kinetics pattern, and it increases with the increase in relative humidity. This stems from the hydrophilic nature of the silica cage, and a maximum water uptake rate of 0.37%/min is achieved.

All these results indicate that a continuous and fast methodology for the fabrication of the composite adsorbent 100 using a scalable approach as illustrated in FIG. 2 is possible, enabling the simultaneous synthesis and shaping of the silica cages while confining the salts. The resultant composites exhibit distinctive water vapor adsorption properties in contrast to the commercial silica adsorbents. Specifically, the SC6-62 composite adsorbent yielded a very high sorption uptake of more than 500%, making it unique for the dehumidification application. The sorption kinetics reveal a very short interval of five minutes to change the adsorption cycle. Further, the composite adsorbent 100 maintained its structural integrity and distinctive performance over plural moisture adsorption cycles. Furthermore, it was showed that the SC6-62 could adsorb and desorb a large amount of water within the ideal operating range. Based on these findings, the composite adsorbent 100 is an ideal candidate for being used in an air conditioning system.

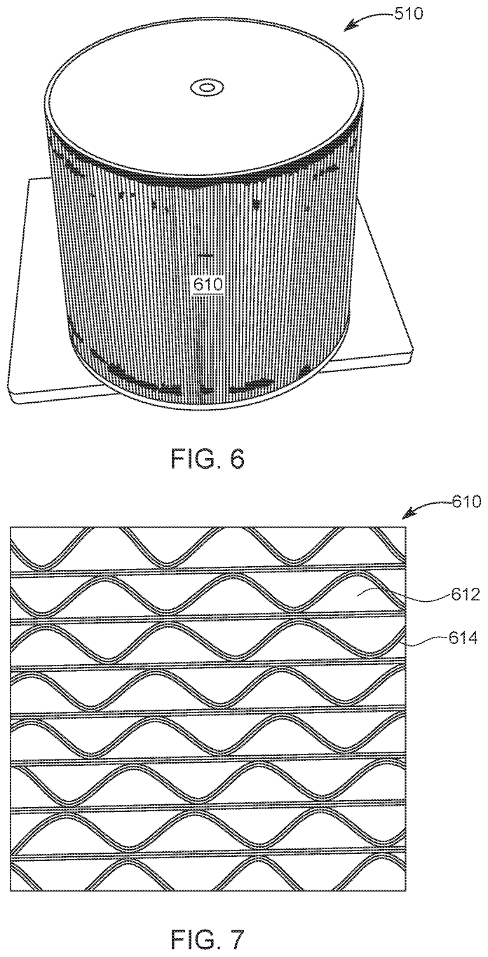

Such an air conditioning system 500 is next discussed. The air conditioning system 500 includes, as illustrated in FIG. 5, an air dehumidification system 502 and an air-cooling device 560. The air dehumidification system 502 is configured to remove the water vapor from the incoming air flow AF1, before being cooled by the air-cooling device 560. For this purpose, the air dehumidification system 502 includes, among other elements, a desiccant wheel 510 placed inside a first Faraday cage 512. The desiccant wheel 510 is shaped to be circular in this embodiment, so that the desiccant wheel can rotate around a longitudinal axis X. In fact, the desiccant wheel 510 has an axle 514, which extends along the axis X, and is coupled to a motor 516. A local controller 520 is programmed to control a speed of the motor 516. Motor 516 could be an AC or DC motor, or any special motors like stepper, brushless, servo, universal type or etc. The local controller 520 can be any logical control or processor based system. The desiccant wheel 510 is made in this embodiment to be a cellulose-based honeycomb structured wheel, as shown in FIG. 6. The cellulose-based material 610 is arranged to form many holes or channels 612, as more specifically illustrated in FIG. 7. The cellulose-based material 610 is then coated with a desiccant 614, which may be the composite adsorbent 100 discussed above.

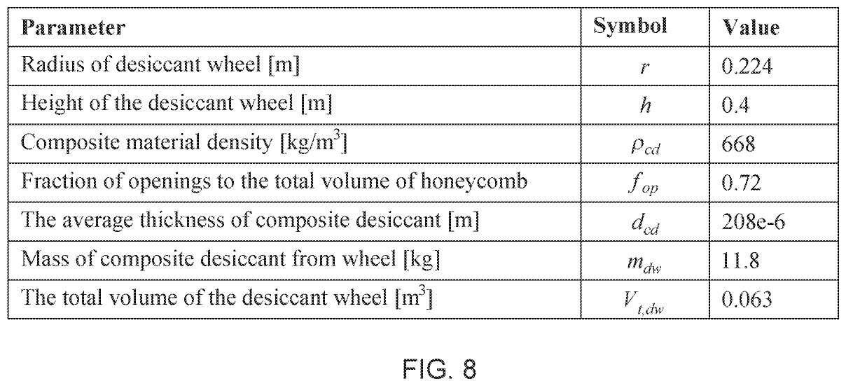

The desiccant wheel 510 has a metallic plate 518 that extends through an entire diameter DD of the wheel, as shown in FIG. 5. The metallic plate 518 essentially divides the wheel into two halves. The metallic plate 518 is configured to reflect the incoming microwave radiation 524, which is generated by a magnetron system 526. The metallic plate 518 may be solid or perforated as long as it is capable of reflecting the incoming radiation 524 back through the desiccant wheel 510. For the position of the desiccant wheel shown in FIG. 5, the incoming radiation 524 enters the top half 510A of the wheel 510, gets reflected at the metallic plate 518, and the reflected waves 524′ traverse a second time the top half 510A of the wheel 510. In this way, the microwaves are spread uniformly through the top half 510A of the wheel 510 for a first time period, and then the same process is repeated for the bottom half 510B of the wheel for a second time period, when the rotation of the wheel has reversed the positions of the top and bottom halves of the wheel. Thus, by controlling the speed of the motor 516, the duration of the first and second time periods is controlled. It is noted that for the small-scale experiments performed in this field, the microwave radiation is typically uniform through the desiccant material. However, when the size of the structure 510 supporting the desiccant material increases (e.g., tens of centimeters in this case), the microwave radiation becomes non-uniform. If this is the case, the regeneration of the desiccant material is affected as the water evaporated from the desiccant material decreases. This problem was not observed by others as all previous research teams dealt only with very small desiccant material support structures. For the embodiment discussed herein, the characteristics of the desiccant wheel 510 are illustrated in the table shown in FIG. 8, and it is noted that the desiccant wheel is quite large, i.e., a cylinder having a radius of about 23 cm and a height of about 40 cm. By controlling the microwave power of a magnetron system 526 (to be discussed next), stub tuner, fan speed, motor speed and rotation, the generated microwave radiation was uniformed. Larger dimensions may be used.

Turning back to FIG. 5, the air dehumidification system 502 further includes a second Faraday cage 530, that contains the first Faraday cage 512, the magnetron system 526, the controller 520, and the motor 516. In one embodiment, a temperature sensor 532 may be placed next to or inside the first Faraday cage 512 for measuring a temperature of the vapor. A distance L from the desiccant wheel 510 to a perforated metal mesh 534, which closes the top and bottom ends of the first Faraday cage 512, may be about 2 mm. The second Faraday cage 530 may also host a water container 536, for storing water 538, which condenses from the water vapors when the desiccant material is regenerated.

The air dehumidification system 502 further includes a first air inlet 540 that is fluidly connected to first and second air dampers AD1 and AD2. An air damper is essentially an air valve that has a closed position when no air passes it, and an open position when air passes it. The air damper may be electronically controlled, for example, by the controller 520, to close or open or to take any open position between closed and fully opened. The air dampers AD1 and AD2 may be connected, in a wired or wireless manner, to the controller 520 so that the controller is capable to control the opening and closing of the air dampers. The air flow conduits from the air dampers AD1 and AD2 merge along a common conduit 542-1 and are fed to an axial fan 544. The speed of the axial fan 544 is also controlled by the controller 520, through a wired or wireless connection. The air flow passing through the conduit 542-1 may enter a flow measuring device 546, which is connected to a differential pressure sensor 548, for measuring a speed of the air flow. The signal measured by the differential pressure sensor 548 is provided to the local controller 520.

The air flow is next provided inside the second Faraday cage 530, at port 550, to the desiccant wheel 510, for either being dehumidified or for being used to regenerate the desiccant material, depending on the cycle of the desiccant wheel 510. The dehumidified air flow AF2 is then extracted from the second Faraday cage 530, at port 552, and it is provided to either a third or a fourth air damper AD3 and AD4, respectively, which are also controlled by the controller 520. The air dampers AD3 and AD4 may have a structure similar to air dampers AD1 and AD2. The air flow received by the third air damper AD3 is discharged at a first air outlet 554, to an air-cooling device 560. The air-cooling device 560 may be any known air chiller that cools or heats an air stream, for example, a refrigeration system that has an evaporator 560-1, a compressor 560-2, a condenser 560-3, and an expansion valve 560-4. Other types of air-cooling devices may be used, for example, the system described in PCT patent application PCT/IB2022/054621, filed on May 18, 2022 (docket no. 0338-640-wo) belonging to the Assignee of the present invention, the entire disclosure of which is incorporated herein by reference. The details of the air-cooling device 560 are omitted herein, as they are presented in the above noted PCT patent application.

The air flow from the fourth air damper AD4 is passing through a heat recovery device 556 to exchange heat with an incoming air stream AF3 flowing through a conduit 542-2. An example of a heat recovery device is described in the PCT patent application discussed above, and thus, its structure is omitted herein. The conduit 542-2 is fluidly connected to a second inlet port 558, which may receive the air from the ambient or a chamber to be cooled or heated, or the air-cooling device 560. The air flow from the fourth air damper AD4, after exiting the heat recovery device 556, is discharged at a second air outlet 562. The second air outlet 562 may be fluidly connected to the ambient, the chamber to be cooled or heated, or the air-cooling device 560. Various air flow and temperature sensors 564 and 566, respectively, may be provided along the various conduits that carry the air to measure the air flow speed and temperature. All this data may be fed either to the local controller 520, or to an external global controller 570, or to both. The external global controller 570 may be a global controller of both the air dehumidification system 502 and the air-cooling device 560. Both the controllers 520 and 570 include at a minimum, a processor and associated memory.

The working principle of microwave dehumidification is based on the hygroscopic character of the desiccant (silica gel or composite adsorbent) that captures water vapor from the air, then water in the desiccant is desorbed by microwave radiation. The feature of microwaves that is advantageous for this process is that they can fluctuate water molecules and desorb them from the adsorbent's surface (e.g., silica gel). Two cases were considered for the air dehumidification system 502: the case without heat recovering (i.e., no heat recovery system 556) and the case with heat recovering from the outlet air. Temperatures and differential pressure readings were logged continuously by the local controller 520 and/or the global controller 570. The desiccant wheel rotating motor 516's speed and rotation modes were controlled by controller 520, and it was running only during the desorption phase, i.e., when water vapor needs to be removed from the desiccant material.

For the case where the heat recovery device 556 was not used, the first air damper AD1 and the third air damper AD3 were opened, and the second air damper AD2 and the fourth air damper AD4 were closed by the controller 520, letting the air bypass the heat recovery device 556. Then, the honeycomb structured desiccant wheel 510 was saturated with moisture at a constant relative humidity and temperature at a regular airflow rate until the inlet and outlet temperatures were the same. Note that the adsorption may proceed at varying relative humidity and temperature and not until full saturation. In this regard, the same temperature and humidity show equilibrium conditions. Consequently, the magnetron system 526 was switched on and microwaves 524 were generated for a preset time and preset power as configured in the local controller 520. The desorption process finished when the outlet 554 humidity ratio becomes lower than the inlet 540 humidity ratio. However, desorption process step may be finished after stopping microwave radiation.

The case with the heat recovery device 556 being active is similar to the case without heat recovery, i.e., when the inlet 540 and outlet 554 temperatures became the same, the first air damper AD1 and the third air damper AD3 are closed, and the second air damper AD2 and the fourth air damper AD4 are opened to recover heat from outlet air.

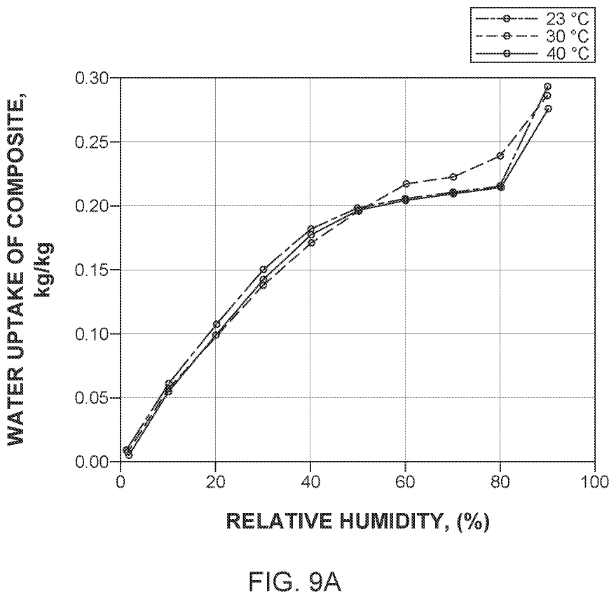

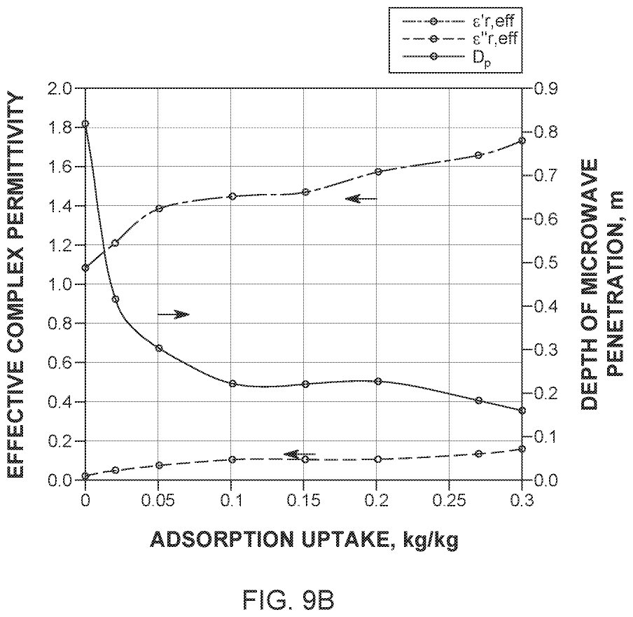

For the two cases noted above, the thickness of the desiccant coating was measured from SEM images, and the average value was 209 μm. A coating thickness may be less or more than this value. A fractured desiccant coating surface was spotted from the SEM images. These fractures intensify the mass transfer and flow of the water vapor. Adsorption isotherms of the desiccant wheel i.e., honeycomb cellulose, adsorbent, and binder were measured as shown in FIG. 9A. The results in this figure show that the desiccant wheel 510 can adsorb water vapor and its mass can reach 30% of the dry bone mass of the desiccant at higher humidity. FIG. 9B shows the dependence of the composite desiccant material's dielectric properties (effective complex permittivity) on the adsorption uptake value. Results in FIG. 9B show that microwaves can reach to the center of the wheel 510. When the amount of adsorbed water decreases, the penetration depth of the electric field increases, and it shows that bigger size desiccant wheel can be regenerated.

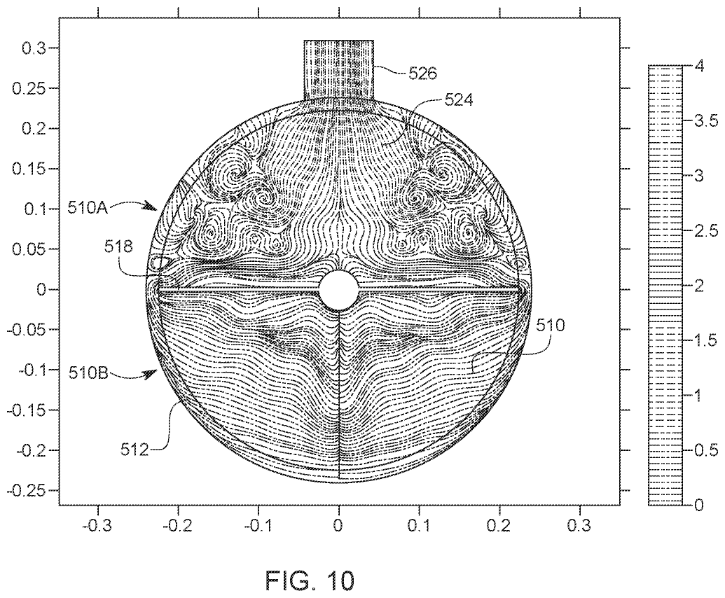

The addition of the metallic plate 518 to the desiccant wheel 510, to extend in a plane that includes the diameter DD of the wheel, was made to more uniformly distribute the microwave power in one half of the wheel, and to minimize the reflected microwave power, and thus, to minimize the unheated areas, for a given cage. Various cages have been investigated and the cylindrical Faraday cage 512 was found to be the most efficient one. In this regard, FIG. 10 shows the streamline of the Poynting vector of microwaves in a cross-section of the cylindrical cage 512, for the desiccant wheel 510 having the metallic plane 518. It is noted that the microwaves 524 are distributed as uniform as possible in the top half 510A of the wheel 510, above the metallic plane 518, and there are no microwaves in the bottom half 510B of the wheel.

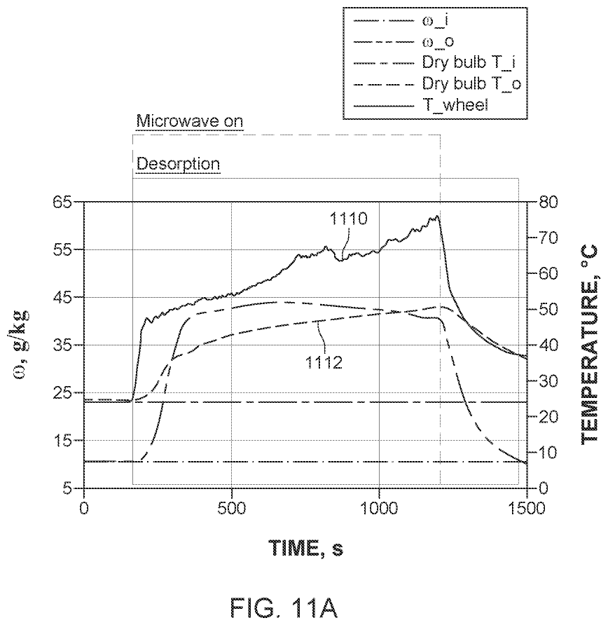

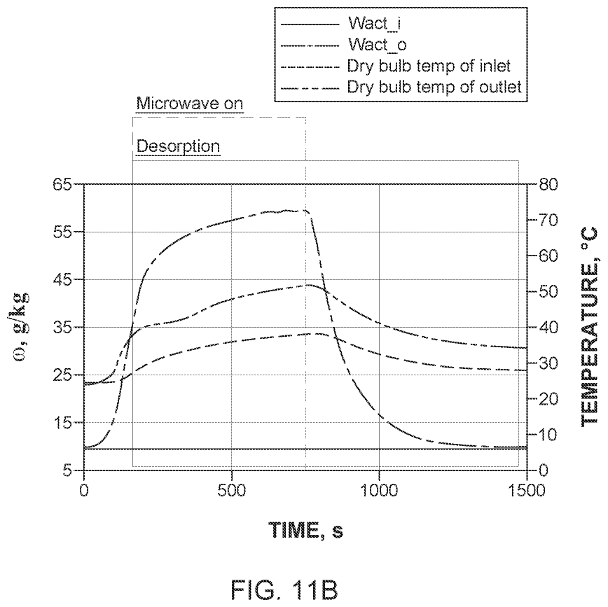

Tests performed on the air dehumidification system 502 without and with heat recovery are now discussed. FIG. 11A shows temperature and humidity ratio profiles at the inlet 540 and outlet 554 of the system 502 with the heat recovery device 556 turned off. Microwave radiation time was set to 17 min. Moreover, microwave radiation time may be longer or shorter than above set time. However, desorption time was longer than the radiation time due to the residual energy (thermal mass of the desiccant wheel). Desorption time may be same as microwave radiation time or longer. Temperature of the inlet air was stable during both adsorption and desorption cycles, and it was equal to 24° C. However, inlet air temperature may vary during the operation. Humidity ratio (w) of the inlet air was stable and equal to 10.3 g/kg throughout the tests. As shown in FIG. 11A, the temperature 1110 of the desiccant wheel 510 increased at the start of microwave radiation. Temperature of the outlet air 1112 increased during microwave radiation, but it was lower than temperature of the wheel. This shows that microwave energy was transported directly to the adsorbed water. Consequently, the desorbed water amount increased, which can be seen from the out flow value of humidity ratio (43 g_{water}/kgₐᵢᵣ). The value of outlet humidity ratio may vary depending on control parameters. An airflow rate during desorption was controlled and its value was equal to 185 m³/h. Airflow rate value may be lower or higher depending on the capacity of the system and other conditions.

The outlet humidity ratio increased after starting of microwave radiation, and the slow increasing at the beginning is due to the thermal mass of the adsorbed water. However, increasing of the outlet humidity ratio cannot be very long, so it starts to decrease. 2 kg of water was desorbed for the current case during the desorption cycle, showing that a large amount of water vapors can be captured and turned into potable water or used to run an indirect evaporative cooling system. Desorbed water amount depends on capacity and may be higher or lower than 2 kg. The COP of the system was 0.55 for the current case, and the MCOP was 0.83. The desiccant wheel's temperature was not too high, which proves the excellent distribution of microwaves and electric field intensity obtained due to the metallic plate 518. A decreasing performance of the system, unheated areas or hotspots were not observed due to the controlled rotating of the metallic plate (stirrer) 518 at the center of the desiccant wheel and this rotation made the system safe and sustainable. Moreover, the temperature of the desiccant material did not exceed 80° C. Nevertheless, some portion of transported microwave energy was observed to be unnecessarily converted to heat as the outlet temperature reached 51° C. This heat can be recovered by using the heat recovery device 556. In this way, the heat from the hot outlet air at air damper AD4 may be used to heat the inlet air flow at the second air inlet 558, and this heated air flow is then provided through the second air damper AD2 to regenerate the desiccant material. In this regard, the various arrows shown in FIG. 5 indicate the flowing direction of the various air flows.

FIG. 11B shows temperature and humidity ratio profiles for the microwave desorption with the heat recovery device 556 turned on. The microwave radiation time was equal to 12 min 20 seconds, and the air flow rate was controlled at 140 m³/h. The temperature of the inlet air increased due to the heat exchange with the hot outlet air flow from the fourth air damper AD4. Moreover, the temperature of the outlet air reached 51° C. after a shorter time than the previous case. Due to heat recovery, the system has the highest COP, its value is equal to 0.58, and the MCOP is equal to 0.87. Moreover, this high COP can be explained from the humidity ratio profile that increased until the microwave irradiation was stopped. Compared with the non-heat recovering case illustrated in FIG. 11A, the present case used the energy more efficiently, so the system's performance was the highest. 1.54 kg of water vapor was desorbed from the desiccant wheel and depending on the capacity desorbed amount of water vapor may be higher or lower.

Further tests of the system 502 were performed to evaluate the amount of desorbed water for different microwave radiation time (3.5-17 minutes) for both cases. The time of desorption may be different depending on capacity of the system. It was found that the desorbed amount of water had almost a linear dependence with time. The results show that the COP increases with the duration of the microwave irradiation for the non-heat recovery case because of the thermal mass of saturated composite desiccant. At the beginning of the microwave radiation, some portion of energy was used for rapid heating of the saturated desiccant wheel from 24° C. to 48° C.(see FIG. 11A), so that the COP was low initially. Running the microwaves longer, it is possible to reduce the effect of the thermal mass and increase the COP of the system. However, microwave irradiation was not more than 17 minutes as most of the water was desorbed (adsorption uptake was 0.03) after this time.

The highest COP (0.58) for the heat recovery case corresponds to the time when the humidity ratio reaches the highest value. The recovered heat can increase the system's performance, but the heat recovery has less effect for a short time or a long time. Meanwhile, the desorbed amount of water for the heat recovery case was more elevated than for the non-heat recovering case.

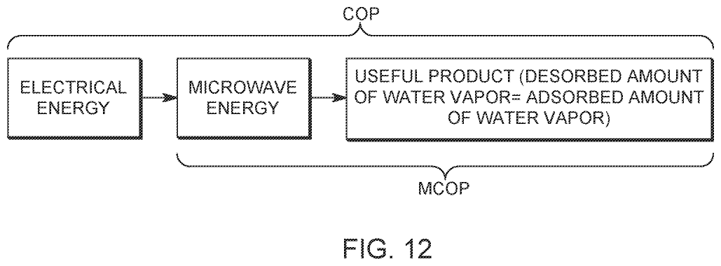

The performance of the system 502 for microwave desorption was also evaluated based on the COP and MCOP, using the following equations:

$$MCOP = \frac{Δm \cdot {h}_{fg}}{{E}_{mw}} , and$$

$$COP = \frac{Δm \cdot {h}_{fg}}{{P}_{elec}} ,$$

where Δm is the desorbed moisture mass, h_{fg} is the evaporation heat, E_{mw} is microwave energy emitted from the magnetron system, and P_{elec} is the consumed electrical energy. Thus, the conversion efficiency η was found to be 0.7. FIG. 12 schematically illustrates the difference between MCOP and COP in the methodology of calculation, with the MCOP taking in consideration only the microwave energy and the energy of the useful product (i.e., desorbed/absorbed water) while the COP also takes into consideration the electrical energy used by the system to generate the microwaves.

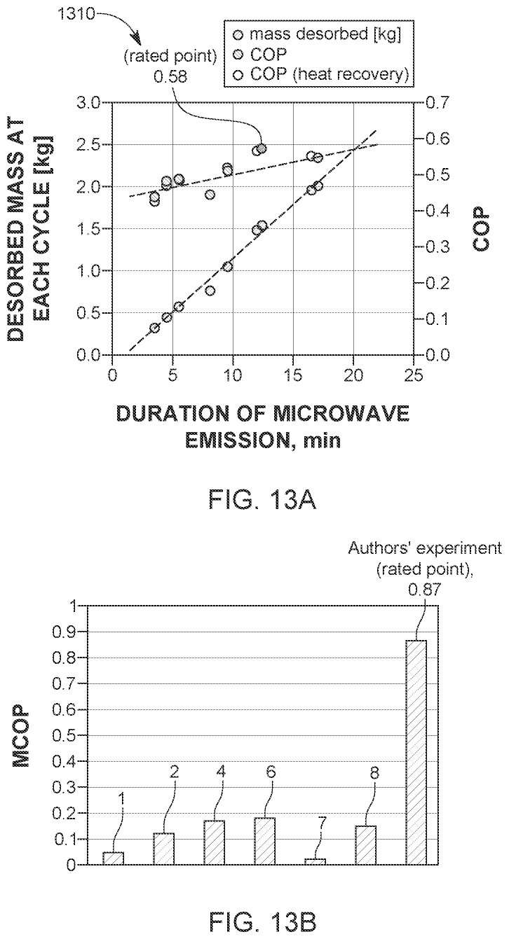

FIG. 13A shows a comparison in terms of the COP for different systems that use microwave desorption. It can be seen that the current system (point 1310) illustrated in FIG. 5, has the highest COP. The MCOP comparison, which is illustrated in FIG. 13B, shows that the current MCOP is 0.87, i.e., fivefold higher than the other systems. These results prove that the novel features disclosed for the system 502 in FIG. 5 improve the efficiency of the dehumidification process, and make the system 502 desirable to be implemented in any air conditioning system that separates the dehumidification process from the cooling/heating process.

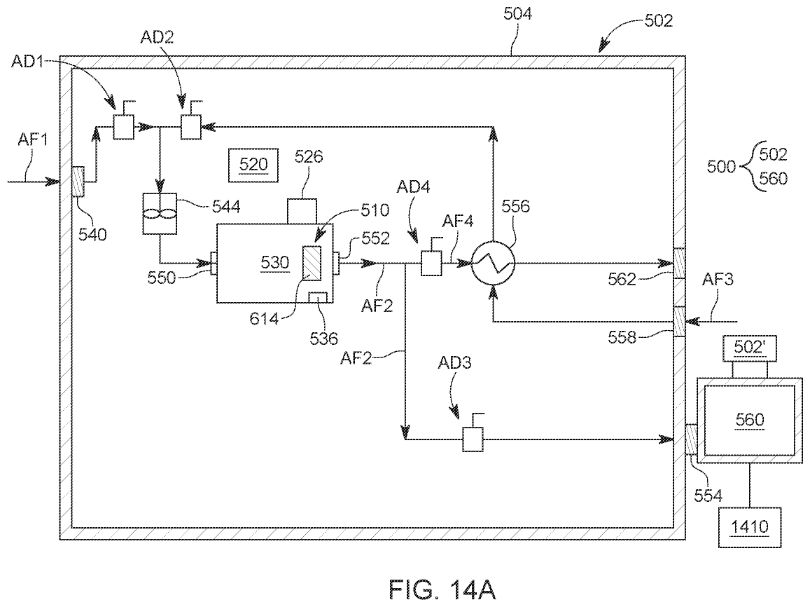

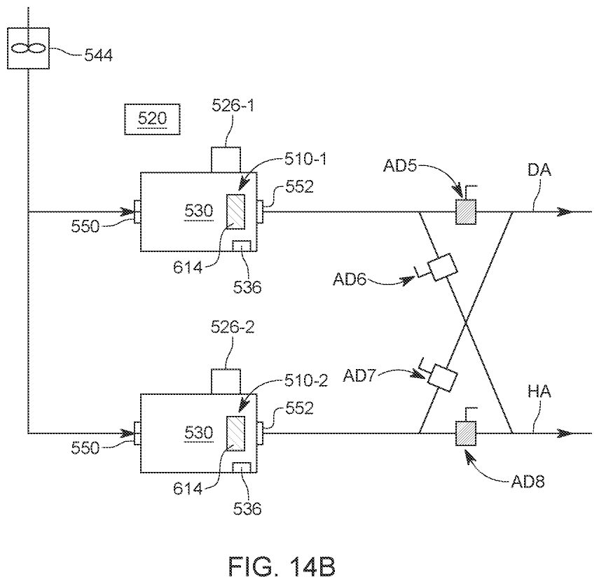

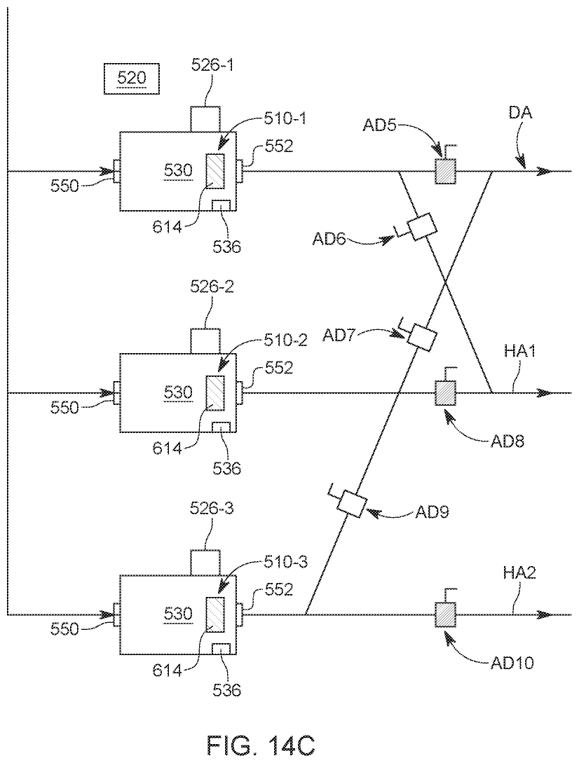

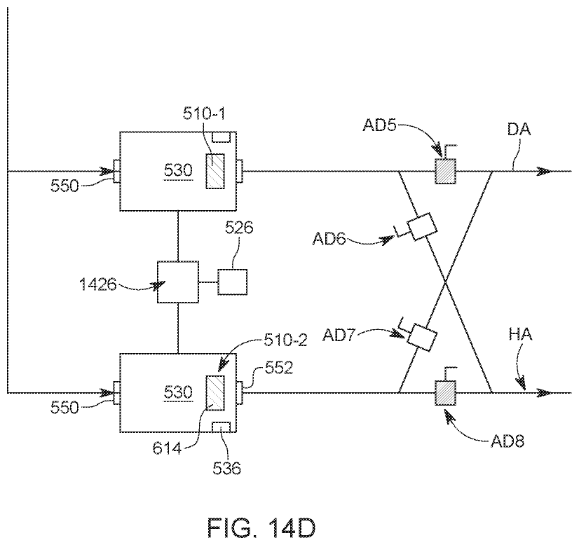

The air conditioning system 500 is configured to work as follows. Depending on an input received at the local controller 520 and/or the global controller 570, the “no heat recovery” mode (also called the “cooling” mode) or the “heat recovery” mode (also called the “regenerating” mode) is selected. For the no heat recovery mode, the controller 520 and/or 570 instructs the first and third air dampers AD1 and AD3 to open and the second and fourth air dampers AD2 and AD4 to close. In this way, the heat recovery device 556 is by-passed by the moving air flows. More specifically, if the incoming air flow AF1 needs to be dehumidified prior to being provided to the air-cooling device 560, the no heat recovery mode is selected. For this case, the incoming air flow AF1 enters the first air inlet 540, passes the first air damper AD1 and arrives at the axial fan 544 (see FIGS. 5 and 14). Note that no air is passing through the second air damper AD2 as this air damper is closed. The fan 544 pushes the air flow through the port 550 into the second Faraday cage 530 and into the desiccant wheel 510. At this point, the incoming air flow AF1 is being dehumidified as the desiccant material 614 deposited on the honeycomb structure of the wheel 510 absorbs the water vapor. The magnetron system 526 is not activated at this time. The dehumidified air flow AF2 exits the second Faraday cage 530 at port 552 and is directed through the opened third air damper AD3 to the air-cooling device 560 for being cooled (or heated). FIG. 14A schematically illustrates the various components of the air dehumidification system 502 being located in a housing 504. FIG. 14A also shows the air-cooling device 560 being fluidly connected, at port 554 with the air dehumidification system 502. Because the fourth air damper AD4 is closed, the entire dehumidified air flow AF2 enters the air-cooling device 560, where it is cooled and then released into a chamber 1410, which is desired to be cooled.

After a given time, which depends on the size of the desiccant wheel 510, the type of the desiccant material 614, the speed of the air flow, and the power of the microwave radiation (or even based on a reading of the temperature sensor 532), the local controller 520 and/or the global controller 570 decides that the desiccant wheel 510 is not effective anymore (i.e., its desiccant material is saturated with water) and needs to be regenerated (i.e., to remove the water from the desiccant material). At this time, the controller 520 closes the first and third air dampers AD1 and AD3, and opens the second and fourth air dampers AD2 and AD4. This means that no air flow from the air dehumidification system 502 is provided to the air-cooling device 560. However, a second air dehumidification system 502′, as illustrated in FIG. 14A, and having an identical structure as the first air dehumidification system 502, may be used during the regeneration period of the desiccant wheel 510 to dehumidify the air provided to the air-cooling device 560 so that the air-cooling device works uninterrupted. The second dehumidifier system 502′ may be controlled by the same local controller 520 and the same global controller 570. This also means that the first dehumidifier system 502 has entered the heat recovery mode while the second dehumidifier system 502′ is in the no heat recovery mode. It can be seen that the two dehumidifier systems 502 and 502′ are used in tandem, i.e., when one is in the no heat recovery mode, the other one is in the heat recovery mode and vice versa.

For the heat recovery mode, the first dehumidifier system 502 activates the magnetron system 526 to evaporate the water stored in the desiccant material 614. Thus, the incoming air flow AF3, which is received at port 558 and is provided to fan 544 and cage 530 via second air damper AD2, removes the evaporated water vapor from the desiccant wheel 510. The water vapor then condensates on the walls of the second Faraday cage 530 or other interior walls and accumulates as condensed water 538 in the container 536 shown in FIGS. 5 and 14. The wet air flow AF4 is then directed by the fourth air damper AD4 to enter the heat recovery device 556 and heats the incoming air flow AF3 before being released into the ambient, at port 562. In this way, the water from the desiccant wheel 510 is removed and thus, the desiccant material is regenerated.

Variations of the system 500 shown in FIG. 14A may be implemented as discussed next. FIG. 14B shows part of the system 500 having two desiccant wheels 510-1 and 510-2 and associated hardware, which are used to remove the water from the incoming air flow and generate a dry air flow DA. When the desiccant wheels are saturated, they enter the regenerate mode, in which hot air is circulated through them to remove the air, which results in the generation of humid air flow HA. Additional air dampers AD5 to AD5 and corresponding piping as shown in the figure may be used to direct dry and humid air flows to the first 554 and second 562 air outlets. Note that each of the desiccant wheel 510-1, 510-2 has its own magnetron system 526-1, 526-2, respectively, for generating the microwaves. In yet another embodiment, as illustrated in FIG. 14C, three desiccant wheels 510-1 to 510-3 and associated hardware are used, with corresponding individual magnetron systems 526-1 to 526-3, respectively. Air dampers AD1 to AD10 are used for directing the dry air flow DA, a first humid air flow HA1, and a second humid air flow HA2. Another variation of the system 500 illustrated in FIG. 14B is illustrated in FIG. 14D. In this embodiment, there are two desiccant wheels 510-1 and 510-2 that share a single magnetron system 526. A waveguide switch 1426 may be used to couple the microwaves from the magnetron system 526 to each of the desiccant wheels 510-1 and 510-2. Variations of the embodiments illustrated in FIGS. 14B to 14D may be implemented by those skilled in the art, for example, the input air streams provided to the various desiccant wheels 510 may be different, i.e., one desiccant wheel receives a humid air stream for dehumidification while another desiccant wheel receives a dry and hot air stream for regeneration so that the desiccant wheels work in tandem. Other variations may be imagined by one skilled in the art having the benefit of the present disclosure.

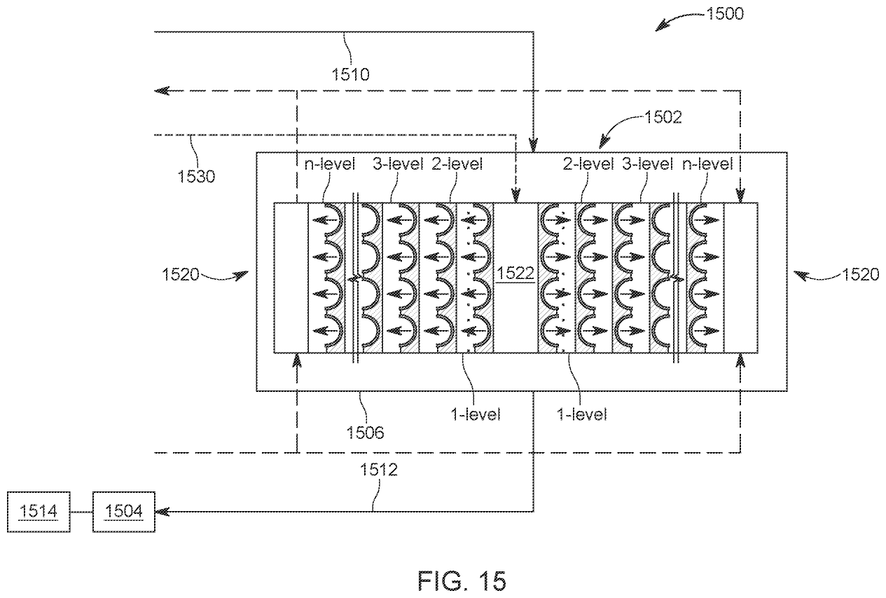

The composite absorbent 100 may be used together with the microwave technique in a different air dehumidification system, as now discussed with regard to FIGS. 15-17. FIG. 15 shows an air conditioning system 1500 that includes an air dehumidification system 1502 and an air-cooling device 1504 (similar to air-cooling device 560). Both systems may be housed in a common housing 1506. The air dehumidification system 1502 may include plural levels or stages, each level being supplied with a humid air stream 1510. The water vapor from the humid air stream 1510 is removed and a dry air stream 1512 is provided at an output port of the air dehumidification system 1502. The air-cooling device 1504 receives the dry air stream 1512, cools it, and then supplies the cold air to an enclosure 1514. The air dehumidification system 1502 also includes a cooling system 1520, located opposite to the microwave generator 1522, for maintaining a temperature gradient along the system. Energy is supplied to the microwave generator 1522 and the cooling system 1520 along energy supply line 1530.

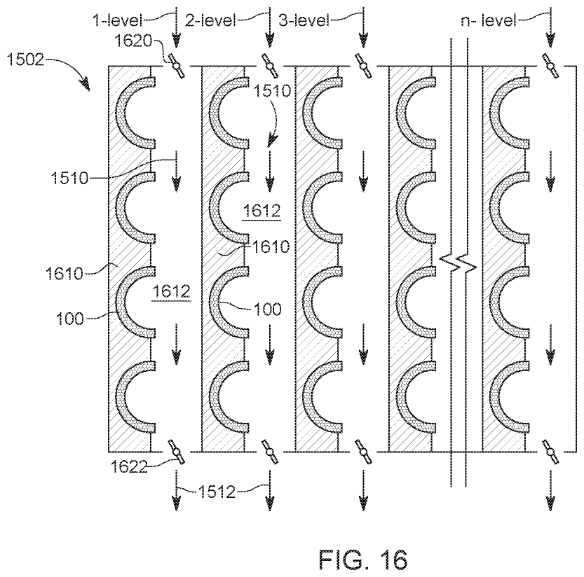

FIG. 16 shows in more detail the interior structure of the plural levels of the air dehumidification system 1502. Each level includes a microwave transparent material 1610 with a high surface area, which is configured to receive the microwave radiation generated by the microwave generator 1522. One side of each of the microwave transparent material 1610 is coated with a solid desiccant, for example, the composite adsorbent 100 previously discussed. Other desiccant materials (e.g., non-composite materials) may be used. The microwave transparent materials 1610 are placed to form air channels 1610, through which the incoming humid air flow 1510 moves. As the humid air flow 1510 moves past the desiccant material 100, the humidity from the air is absorbed, which results in the dry air flow 1512. Note that during this stage, the microwave generator 1522 is turned off. The two ends of the channels 1610 are provided with corresponding valves 1620 and 1622, respectively, for controlling the air flow through the channels. The microwave radiation passing through the channel 1612 of the first level may enter the microwave transparent material 1610 of the second level and the processes discussed above with regard to the first level are repeated in the second level. In this way, the humidity from the incoming air flow 1510 is adsorbed by the desiccant material of each stage.

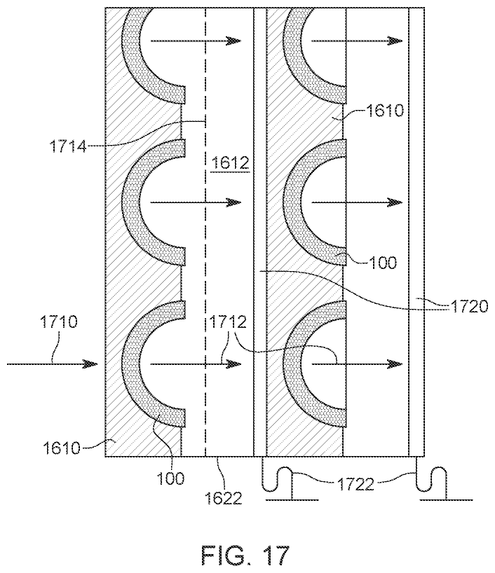

When the desiccant material 100 is saturated with water, the valves 1620 and 1622 are closed, as shown in FIG. 17, and the microwave generator 1522 is turned on so that microwaves 1710 are formed and passing through each stage. The microwave radiation evaporates the water from the desiccant material 100, forming water vapor 1712. A metal mesh layer 1714 may be placed inside the air channel 1612 of the first stage to prevent the microwave radiation to reach the second or subsequent stages. If this is the case, the heated water vapor 1712 from the first stage moves past the metal mesh layer 1714 and heats the microwave transparent material 1610 to heat the desiccant material in the second stage, and evaporates the water from it. For this case, the material 1610 may be a high conductive material with a high surface area. The water vapor 1712 from the air channel 1612 condenses on the back of the material 1610 of the second level, as shown in FIG. 17, and forms condensed water 1720, which is collected by a water discharge system 1722 and removed from the air dehumidification system 1502. In this way, the desiccant material 100 is regenerated and prepared for a new cycle for removing the humidity from the incoming air flow 1510. By closing and opening the valves 1620 and 1622, the controller of the system switches the various levels between dehumidification and regeneration. For the regeneration mode, it is possible to have the microwave radiation propagate through all the levels or, only through the first level, and the generated vapor stream is then used to evaporate the water from the desiccant material of the other levels.

The disclosed embodiments provide an air dehumidification system and air conditioning system that more efficiently dehumidifies the air using microwaves radiation. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] F. H Akhtar, H. Vovushua, L. F. Villalobos, R. Shevate, M. Kumar, S. P. Nunes, U. Schwingenschlögl, K.-V. Peinemann, Highways for water molecules: interplay between nanostructure and water vapor transport in block copolymer membranes, J. Membr. Sci. 572 (2019) 641-649.
[2] F. H. Akhtar, M. Kumar, K.-V. Peinemann, Pebax® 1657/Graphene oxide composite membranes for improved water vapor separation, J. Membr. Sci. 525 (2017) 187-194.
[3] G. Roussy, P. Chenot, Selective energy supply to adsorbed water and nonclassical thermal process during microwave dehydration of zeolite, J. Phys. Chem. 85 (1981) 2199-2203. https://doi.org/10.1021/j150615a013.
[4] G. Roussy, A. Zoulalian, M. Charreyre, J. M. Thiebaut, How microwaves dehydrate zeolites, J. Phys. Chem. 88 (1984) 5702-5708. https://doi.org/10.1021/j150667a049.
[5] I. Polaert, L. Estel, R. Huyghe, M. Thomas, Adsorbents regeneration under microwave irradiation for dehydration and volatile organic compounds gas treatment, Chem. Eng. J. 162 (2010) 941-948. https://doi.org/10.1016/J.CEJ.2010.06.047.
[6] O. Tatsuo, W. Akiko, Simple suppressing method of thermal runaway in microwave heating of zeolite and its application, PhysChemComm. 4 (2001) 18-20. https://doi.org/10.1039/B009067K.
[7] S. I to, H. Huang, F. Watanabe, H. Yuan, M. Hasatani, N. Kobayashi, Heat Transfer during Microwave-Assisted Desorption of Water Vapor from Zeolite Packed Bed, Https://Doi.org/10.1080/07373937.2012.714825. 30 (2012) 1707-1713. https://doi.org/10.1080/07373937.2012.714825.
[8] M. Kubota, T. Hanada, S. Yabe, D. Kuchar, H. Matsuda, Water desorption behavior of desiccant rotor under microwave irradiation, Appl. Therm. Eng. 31 (2011) 1482-1486. https://doi.org/10.1016/J.APPLTHERMALENG.2011.01.027.
[9] M. Kubota, T. Hanada, S. Yabe, H. Matsuda, Regeneration characteristics of desiccant rotor with microwave and hot-air heating, Appl. Therm. Eng. 50 (2013) 1576-1581. https://doi.org/10.1016/J.APPLTHERMALENG.2011.11.044.

1. A composite adsorbent for adsorbing water, the composite adsorbent comprising:
a silica-cage having plural pores and internal channels that fluidly connect the plural pores;
at least one interior chamber having an average diameter larger than an average diameter of the plural pores, wherein the at least one interior chamber is a result of a collapse of at least one pore of the plural pores and one channel of the internal channels; and
a salt provided within the plural pores, the internal channels and the at least one interior chamber.

2. The composite adsorbent of claim 1, wherein the salt includes LiCl.

3. The composite adsorbent of claim 1, wherein the silica-cage is spherical and has an average external diameter of about 6 μm.

4. The composite adsorbent of claim 3, wherein a loading of the silica-cage with the salt is about 62%, wherein the loading is defined as a ratio between (1) a volume of the salt and (2) a total volume of the plural pores, internal channels, and the at least one internal chamber.

5. An air dehumidification system for removing water vapor from an air flow, the air dehumidification system-comprising:
a first Faraday cage configured to confine microwaves;
a desiccant wheel located within the first Faraday cage and configured to rotate relative to a longitudinal axis X of the first Faraday cage, wherein the desiccant wheel is coated with a desiccant material;
a metallic plane that extends through a diameter DD of the desiccant wheel and divides the desiccant wheel into a first half and a second half; and
a magnetron system configured to generate the microwaves and direct them into the desiccant wheel to evaporate water adsorbed by the desiccant material,
wherein the metallic plane is configured to, at a given instant, uniformly distribute the microwaves into the first half of the desiccant wheel and to prevent the microwaves from the entering the second half.

6. The system of claim 5, further comprising:
a motor configured to rotate the desiccant wheel relative to the generated microwaves; and
a local controller configured to control the motor and the magnetron system.

7. The system of claim 6, further comprising:
a housing that hosts the first Faraday cage, the motor, and the magnetron system, wherein the housing acts as a second Faraday cage.

8. The system of claim 7, further comprising:
a fan configured to move air through the system; and
first to four air dampers configured to control the air flow to the fan.

9. The system of claim 8, wherein the first and second air dampers control an incoming air flow to the desiccant wheel, the third air damper controls a dehumidified air flow to an air-cooling device, after passing the desiccant wheel, and the fourth air damper controls a wet air flow to a heat recovery device.

10. The system of claim 9, wherein the controller is configured to open the first and third air dampers and close the second and fourth air dampers during a no heat recovery mode.

11. The system of claim 10, wherein the controller is further configured to close the first and third air dampers and open the second and fourth air dampers during a heat recovery mode.

12. The system of claim 11, further comprising:
the heat recovery device, which is configured to receive, during the heat recover mode, the wet air flow from the fourth air damper and to transfer heat from the wet air flow to the incoming air flow that is provided to the second air damper.

13. The system of claim 8, further comprising:
an air-cooling device fluidly connected to the third air-damper for receiving a dry air flow.

14. The system of claim 5, wherein the desiccant wheel is shaped to be cylindrical, is made of cellulose, and has a honeycomb structure.

15. The system of claim 5, wherein the desiccant material comprises:
a silica-cage having plural pores and internal channels that fluidly connect the plural pores;
at least one interior chamber having an average diameter larger than an average diameter of the plural pores, wherein the at least one interior chamber is a result of a collapse of at least one pore of the plural pores and one channel or the internal channels; and
a salt-provided within the plural pores, the internal channels and the at least one interior chamber.

16. The system of claim 15, wherein the salt includes LiCl, the silica-cage is spherical and has an average external diameter of about 6 μm.

17. The system of claim 16, wherein a loading of the silica-cage with the salt is about 62%, wherein the loading is defined as a ratio between (1) a volume of the salt and (2) a total volume of the plural pores, internal channels, and the at least one internal chamber.

18. A method for manufacturing a composite adsorbent for adsorbing water, the method comprising:
providing a silica-cage having plural pores and internal channels that fluidly connect the plural pores;
preparing an aqueous salt that includes a salt;
placing the silica-cage in the aqueous salt to form at least one interior chamber, which is a result of a collapse of at least one pore of the plural pores and one channel of the internal channels;
removing the silica-cage loaded with the salt from the aqueous salt; and
drying the silica-cage loaded with the salt.

19. The method of claim 18, wherein the salt includes LiCl, and the silica-cage is spherical and has an average external diameter of about 6 μm.

20. The method of claim 18, further comprising:
exposing the silica-cage with the salt to vacuum to increase a salt loading to about 62%, wherein the loading is defined as a ratio between (1) a volume of the salt and (2) a total volume of the plural pores, internal channels, and the at least one internal chamber.
